(19) United States
(12) Patent Application Publication
(10) Pub. No.: US 2019/0280850 A1
(43) Pub. Date: Sep. 12, 2019

(54) Techniques For Word Alignment Based On Transition Density

(71) Applicant: Intel Corporation, Santa Clara, CA (US)

(72) Inventors: Chee Seng Tan, Penang (MY); Boon Hong Oh, Penang (MY); Ivan Fu Sun Teh, Penang (MY)

(73) Assignee: Intel Corporation, Santa Clara, CA (US)

(21) Appl. No.: 16/424,071

(22) Filed: May 28, 2019

(51) Int. Cl. H04L 7/00; H04L 7/04

(52) U.S. Cl. CPC H04L 7/0087; H04L 7/042; H04L 7/044

(57) ABSTRACT

A receiver circuit includes a transition density detector circuit that generates a transition density signal based on a comparison between a transition density of data words to a transition density threshold. The receiver circuit also includes a bit shift and pattern detector circuit that bit shifts one of the data words to generate bit shifted data in response to the transition density signal indicating that the transition density of the data words has reached the transition density threshold. The bit shift and pattern detector circuit counts a number of bits shifts performed on the bit shifted data to locate a synchronization character. The receiver circuit also includes a word alignment circuit that bit shifts the data words by the number of bits shifts to generate word aligned data.

### FIELD OF THE DISCLOSURE

The present disclosure relates to electronic circuits, and more particularly, to techniques for performing word alignment of data based on the transition density.

### BACKGROUND

In most interface protocols, unique synchronization characters are used as markers to perform word alignment. In application specific integrated circuit (ASIC) designs, synchronization character detection logic in the physical (PHY) layer functions directly on the incoming data. Field programmable gate array (FPGA) designs generally process incoming data streams as bit-wide selectable words of data using a clock signal that may be a corresponding fraction of the incoming data stream clock signal.

Some protocols, such as High-Definition Multimedia Interface (HDMI) 2.0, have requirements that involve the detection of non-unique synchronization characters that are only transmitted once in a frame, where the boundary of the frame is a variable that depends on the video resolution. HDMI protocol design complexity has increased with every protocol iteration from HDMI 1.3× and 1.4×, to 2.0, as a result of the addition of new frame formats, packet types, encryption, encoding, and scrambling.

According to HDMI 2.0, all characters in a video frame are scrambled and then encoded using transition-minimized differential signaling (TMDS), except 8 sequential unscrambled synchronization characters. The 8 sequential unscrambled synchronization characters are only sent once per video frame and are used by the receiver for word boundary alignment. Adding to the complexity, the scrambled data may appear as a non-unique synchronization character. For this reason, the HDMI 2.0 specification requires 8 consecutive synchronization characters to be sent for word alignment.

A bit-slipping technique iteratively slips one bit in the received parallel data at an arbitrary interval until the correct word boundary is detected. A pattern matching technique scans for desired sequential patterns over all possible bit locations to achieve word alignment. A hard word aligner in an external ASIC uses a transceiver with an application specific word aligner for the HDMI protocol.

### BRIEF DESCRIPTION OF THE DRAWINGS

FIG. 1 illustrates an example of a receiver circuit that performs word alignment of received data based on a transition density difference between synchronization characters and data characters in the received data, according to an embodiment.

FIG. 2 illustrates details of an exemplary embodiment of the transition density detector circuit of FIG. 1.

FIG. 3 illustrates details of an exemplary embodiment of the bit shift and pattern detector circuit of FIG. 1.

FIG. 4 illustrates details of an exemplary embodiment of the word alignment circuit of FIG. 1.

FIG. 5 illustrates examples of operations that perform word alignment of received data based on the transition density of the data, according to an embodiment.

### DETAILED DESCRIPTION

In the HDMI 2.0 protocol, the dynamic, infrequent, and non-unique nature of the 8 sequential unscrambled synchronization characters pose challenges to the receiver alignment logic in achieving optimum resource usage and synchronization lock time. Industry requirements often specify that video lock needs to be achieved in under 1 second. Synchronization lock when not handled correctly contributes significantly to overall video lock latency upon cable plugging or resolution switching. Video lock latency may violate the industry requirement for the video lock time.

According to some embodiments disclosed herein, a receiver circuit detects synchronization characters in received data to perform word alignment based on the transition density difference between the synchronization characters and data characters. The synchronization characters in the received data have a high transition density, and the data characters have a low transition density. The receiver circuit monitors the transition density of the received data. If the transition density of the received data reaches a predefined threshold at one or more symbol times, one or more data words are stored for further processing. Then, a stored data word is bit shifted to detect the synchronization characters that indicate the word boundary. After the word boundary is identified, the received data is shifted by the number of bit shifts that were performed to detect the synchronization characters. The word boundary can be confirmed upon detecting a predefined number of consecutive synchronization characters received in the shifted data according to the protocol.

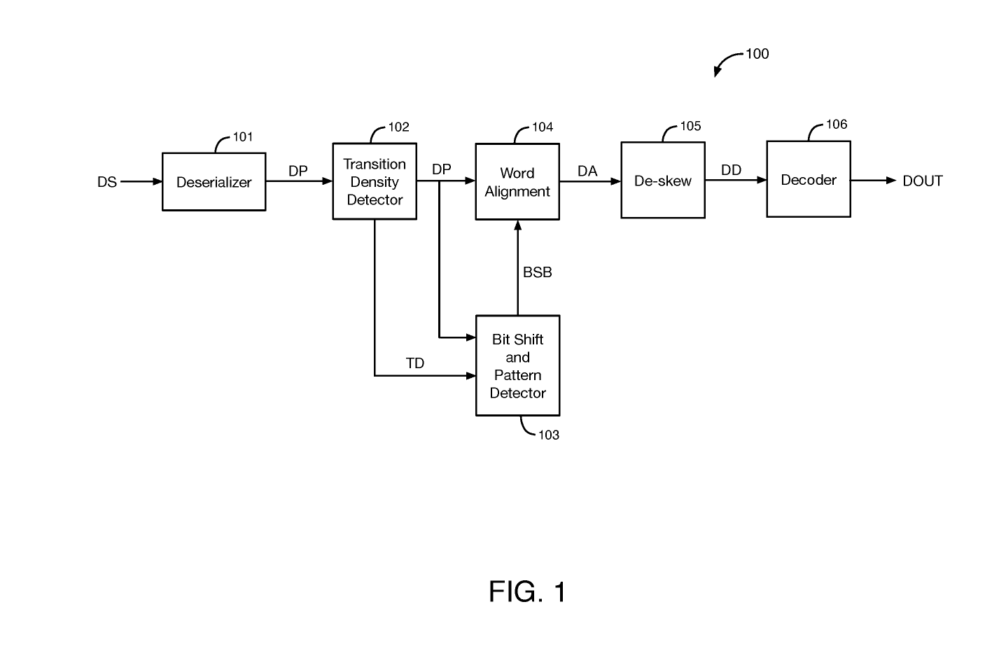

FIG. 1 illustrates an example of a receiver circuit 100 that performs word alignment of received data based on a transition density difference between synchronization characters and data characters in the received data, according to an embodiment. Receiver circuit 100 includes a deserializer circuit 101, a transition density detector circuit 102, a bit shift and pattern detector circuit 103, a word alignment circuit 104, a de-skew circuit 105, and a decoder circuit 106. Receiver circuit 100 can be manufactured in any type of integrated circuit (IC), such as a programmable logic integrated circuit (e.g., a field programmable gate array), a microprocessor/central processing unit (CPU) IC, or a graphics processing unit (GPU).

Referring to Figure (FIG. 1, a serialized stream of input data DS is transmitted to an input of deserializer circuit 101 from an external source (e.g., another IC). Deserializer circuit 101 may, for example, include a clock data recovery (CDR) circuit and a serial-to-parallel converter circuit. The CDR circuit generates a recovered clock signal in response to the input data DS. The serial-to-parallel converter circuit converts the serial data bits indicated by input data DS into parallel data bits in parallel output data signals DP in response to the recovered clock signal generated by the CDR circuit. In an exemplary embodiment that is not intended to be limiting, deserializer circuit 101 is configured to double the character width, for example, to parallelize the serial data DS into 20 bit data words in parallel data signals DP for the HDMI protocol. Upon any data rate change, the receiver circuit 100 is reconfigured and reset. After reset, the word boundary in the deserialized data signals DP changes and re-alignment is performed, as described below.

The parallel data signals DP are provided to inputs of transition density detector circuit 102. Transition density detector circuit 102 monitors the transition density of each data word in the parallel data signals DP. Transition density detector circuit 102 determines the transition density of each data word in the parallel data signals DP. Transition density detector circuit 102 then compares the transition density of each data word in parallel data signals DP to a predetermined transition density threshold. If the transition density detector circuit 102 determines that the transition density of one or more data words in signals DP is equal to or greater than the transition density threshold, then transition density detector circuit 102 asserts output signal TD. If the transition density detector circuit 102 determines that the transition density of one or more of the data words is less than the transition density threshold, then transition density detector circuit 102 de-asserts output signal TD. The transition density detector circuit 102 passes the parallel data signals DP to its outputs without modifying the parallel data signals DP. The parallel data signals DP are then provided to inputs of bit shift and pattern detector circuit 103 and to inputs of word alignment circuit 104.

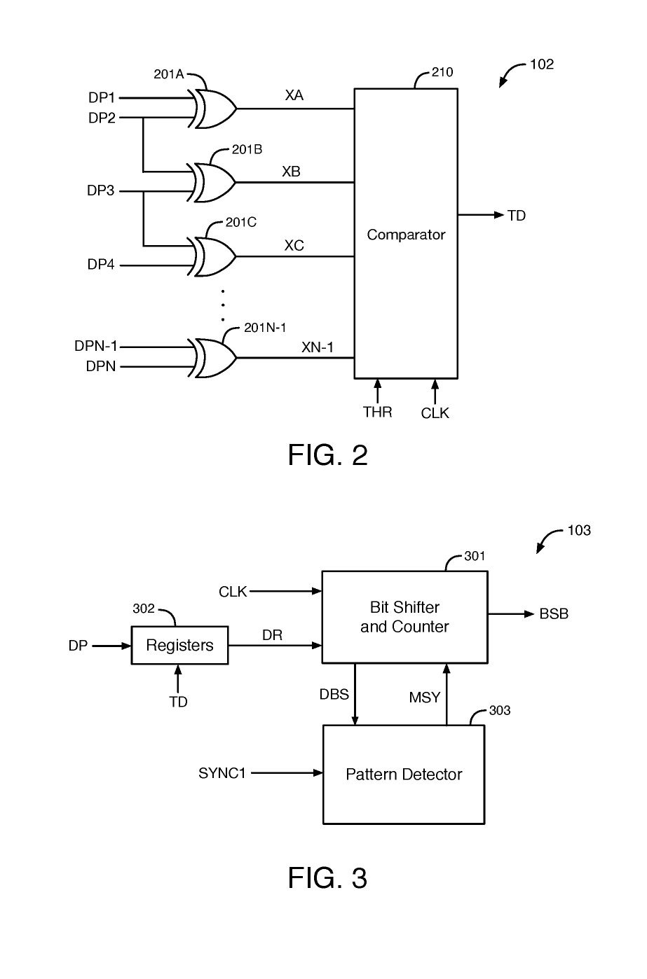

FIG. 2 illustrates details of an exemplary embodiment of the transition density detector circuit 102 of FIG. 1. In the embodiment of FIG. 2, transition density detector circuit 102 includes XOR gate circuits 201 and a comparator circuit 210. Also, the parallel data signals DP have an N number of parallel signals, including signals DP1, DP2, DP3, DP4, DPN−1, and DPN. Each of the parallel data signals indicates a different data bit in each unit interval. In the embodiment of FIG. 2, transition density detector circuit 102 includes an N−1 number of XOR gate circuits 201, including XOR gate circuits 201A, 201B, 201C, and 201N−1.

Each adjacent pair of two of the parallel data signals DP are provided to inputs of a different one of the XOR gate circuits 201 in sequential order. For example, parallel data signals DP1 and DP2 are provided to inputs of XOR gate circuit 201A, parallel data signals DP2 and DP3 are provided to inputs of XOR gate circuit 201B, and parallel data signals DP3 and DP4 are provided to inputs of XOR gate circuit 201C. Each of the XOR gate circuits 201 performs a Boolean XOR function on its two input signals to generate an output signal. For example, XOR gate circuits 201A, 201B, 201C, and 201N-1 generate output signals XA, XB, XC, and XN−1. The XOR gate circuits 201 are able to determine if there is a transition in the logic state between the two bits in each adjacent pair of the parallel data signals DP. Each of the XOR gate circuits 201 generates a logic high in its output signal if there is a logic state transition between its input signals and a logic low in its output signal if there is not a logic state transition between its input signals. The number of logic high states in the output signals of XOR gate circuits 201 indicates the transition density of the data word that is currently indicated by parallel data signals DP1-DPN.

The output signals of XOR gate circuits 201 are provided to inputs of comparator circuit 210. Comparator circuit 210 compares the transition density indicated by the output signals of XOR gate circuits 201 to a transition density threshold that is indicated by signals THR. Comparator circuit 210 determines if the transition density indicated by the output signals of XOR gate circuits 201 is greater than or equal to the transition density threshold indicated by signals THR.

As an example that is not intended to be limiting, the transition density threshold for HDMI may be 13. In this example, the HDMI 2.0 protocol requires 8 continuous TMDS synchronization characters to be transmitted once per video frame to facilitate word alignment. In this implementation, the deserialized TMDS synchronization and data characters are processed in 20-bit data chunks.

According to an exemplary embodiment of FIG. 2, if comparator circuit 210 determines that the transition density of 3 consecutive data words in signals DP, as indicated by the output signals of XOR gate circuits 201, equals or exceeds the transition density threshold for 3 continuous clock cycles of a clock signal CLK (e.g., t+1, t+2, and t+3), comparator circuit 210 asserts its transition density output signal TD. Thus, upon detection of the first data word to equal or exceed the transition density threshold (e.g., 13 bit transitions), comparator circuit 210 only asserts signal TD if the subsequent 2 data words in signals DP also equal or exceed the transition density threshold. Prior to detecting 3 consecutive data words equaling or exceeding the transition density threshold, comparator circuit 210 de-asserts signal TD.

Table 1 below contains examples of data indicated by signals DP and provided in 20-bit data words (bits 0-19) that exceed the transition density threshold of 13 at 3 consecutive clock cycles t+1, t+2, and t+3. In the example of Table 1, the data words received in clock cycles t+1, t+2, and t+3 include the synchronization characters. The data shown in Table 1 is provided as an example and is not intended to be limiting.

TABLE 1

| Clock cycle | t | t + 1 | t + 2 | t + 3 | t + 4 | t + 5 |
|---|---|---|---|---|---|---|
| Bit 19 | 1 | 0 | 0 | 1 | 1 | 0 |
| Bit 18 | 1 | 0 | 0 | 1 | 1 | 0 |
| Bit 17 | 0 | 0 | 0 | 1 | 1 | 0 |
| Bit 16 | 0 | 0 | 0 | 1 | 1 | 0 |
| Bit 15 | 0 | 1 | 1 | 0 | 0 | 1 |
| Bit 14 | 0 | 0 | 0 | 1 | 1 | 0 |
| Bit 13 | 0 | 1 | 1 | 0 | 0 | 1 |
| Bit 12 | 0 | 0 | 0 | 1 | 1 | 1 |
| Bit 11 | 1 | 1 | 1 | 0 | 0 | 0 |
| Bit 10 | 0 | 0 | 0 | 1 | 1 | 1 |
| Bit 9 | 1 | 1 | 1 | 0 | 0 | 0 |
| Bit 8 | 1 | 1 | 1 | 0 | 0 | 1 |
| Bit 7 | 1 | 1 | 0 | 0 | 1 | 0 |
| Bit 6 | 1 | 1 | 0 | 0 | 1 | 0 |
| Bit 5 | 0 | 0 | 1 | 1 | 0 | 0 |
| Bit 4 | 1 | 1 | 0 | 0 | 0 | 0 |
| Bit 3 | 0 | 0 | 1 | 1 | 1 | 1 |
| Bit 2 | 1 | 1 | 0 | 0 | 1 | 0 |
| Bit 1 | 0 | 0 | 1 | 1 | 0 | 0 |
| Bit 0 | 1 | 1 | 0 | 0 | 0 | 1 |
| Transition | 10 | 13 | 14 | 13 | 11 | 11 |
| Density | | | | | | |

Transition density detector circuit 102 provides signal TD to bit shift and pattern detector circuit 103. Circuit 103 stores data words received in signals DP (e.g., 3 data words received in the 3 previous clock cycles t+1, t+2, and t+3) in response to transition density detector circuit 102 asserting signal TD. Bit shift and pattern detector circuit 103 bit shifts the first data word received at clock cycle t+1 in data signals DP (e.g., 1 bit per clock cycle) to locate a synchronization character. The synchronization character can be a sequence of binary bits that is defined by a transmission protocol, such as HDMI or another protocol. Bit shift and pattern detector circuit 103 counts the number of bit shifts performed on the first data word received at clock cycle t+1 to locate the synchronization character. Bit shift and pattern detector circuit 103 outputs the number of bit shifts performed on the first data word to locate the synchronization character as the bit shift count in signals BSB.

FIG. 3 illustrates details of an exemplary embodiment of the bit shift and pattern detector circuit 103 of FIG. 1. In the embodiment of FIG. 3, bit shift and pattern detector circuit 103 includes bit shifter and counter circuit 301, register circuits 302, and pattern detector circuit 303. The parallel data signals DP and the transition density signal TD are provided to inputs of registers 302. Registers 302 store one or more of the data words received in signals DP (e.g., the 3 data words received in the 3 previous clock cycles t+1, t+2, and t+3) in response to transition density detector circuit 102 asserting signal TD. Registers 302 then output the first data word received at clock cycle t+1 as parallel data signals DR to bit shifter and counter circuit 301 in response to signal TD being asserted.

A bit shifter in circuit 301 bit shifts the first data word received from registers 302 as the parallel data signals DR by one bit in each clock cycle of clock signal CLK to generate bit shifted data in data signals DBS after signal TD is asserted. As a result, the bit shifted data in signals DBS is bit shifted by one bit in each cycle of clock signal CLK relative to the data word indicated by signals DR. Circuit 301 also includes a digital counter circuit that counts the number of bit shifts that the bit shifter performs on the bit shifted data indicated by signals DBS. Data signals DBS are provided to inputs of pattern detector circuit 303.

Pattern detector circuit 303 compares the bit shifted data indicated by signals DBS to a synchronization character indicated by input signals SYNC1. In response to pattern detector circuit 303 detecting that the bit shifted data indicated by signals DBS matches the synchronization character indicated by input signals SYNC1, pattern detector circuit 303 asserts its output signal MSY. Signal MSY is provided from pattern detector circuit 303 to an input of bit shifter and counter circuit 301.

Bit shifter and counter circuit 301 counts the number B of bits shifts performed on the bit shifted data indicated by signals DBS to cause the bit shifted data to match the synchronization character indicated by signals SYNC1. Bit shifter and counter circuit 301 counts the number B of bit shifts performed on the bit shifted data (e.g., as indicated by the number of clock cycles) until signal MSY is asserted. Pattern detector circuit 303 asserts signal MYS in response to the bit shifted data matching the synchronization character. As a specific example that is not intended to be limiting, the bit shifter can bit shift a 20-bit data word stored at clock cycle t+1 by 1 bit per clock cycle until the 10 least significant bits of the data word match the synchronization character.

Table 2 below shows an example of a 20-bit data word (bits 0-19) received in signals DR that is bit shifted by 8 bits in 8 consecutive clock cycles by bit shifter circuit 301, until pattern detector circuit 303 detects that the 10 least significant bits (bits 0-9) match the synchronization character in clock cycle t+12.

TABLE 2

| | Clock cycle | | | | | | | | |
|---|---|---|---|---|---|---|---|---|---|
| | t + | t + | t + | t + | t + | t + | t + | t + | t + |
| | 4 | 5 | 6 | 7 | 8 | 9 | 10 | 11 | 12 |
| Bit shift | 0 | 1 | 2 | 3 | 4 | 5 | 6 | 7 | 8 |
| count B | | | | | | | | | |
| Bit 19 | 0 | | | | | | | | |
| Bit 18 | 0 | 0 | | | | | | | |
| Bit 17 | 0 | 0 | 0 | | | | | | |
| Bit 16 | 0 | 0 | 0 | 0 | | | | | |
| Bit 15 | 1 | 0 | 0 | 0 | 0 | | | | |
| Bit 14 | 0 | 1 | 0 | 0 | 0 | 0 | | | |
| Bit 13 | 1 | 0 | 1 | 0 | 0 | 0 | 0 | | |
| Bit 12 | 0 | 1 | 0 | 1 | 0 | 0 | 0 | 0 | |
| Bit 11 | 1 | 0 | 1 | 0 | 1 | 0 | 0 | 0 | 0 |
| Bit 10 | 0 | 1 | 0 | 1 | 0 | 1 | 0 | 0 | 0 |
| Bit 9 | 1 | 0 | 1 | 0 | 1 | 0 | 1 | 0 | 0 |
| Bit 8 | 1 | 1 | 0 | 1 | 0 | 1 | 0 | 1 | 0 |
| Bit 7 | 1 | 1 | 1 | 0 | 1 | 0 | 1 | 0 | 1 |
| Bit 6 | 1 | 1 | 1 | 1 | 0 | 1 | 0 | 1 | 0 |
| Bit 5 | 0 | 1 | 1 | 1 | 1 | 0 | 1 | 0 | 1 |
| Bit 4 | 1 | 0 | 1 | 1 | 1 | 1 | 0 | 1 | 0 |
| Bit 3 | 0 | 1 | 0 | 1 | 1 | 1 | 1 | 0 | 1 |
| Bit 2 | 1 | 0 | 1 | 0 | 1 | 1 | 1 | 1 | 0 |
| Bit 1 | 0 | 1 | 0 | 1 | 0 | 1 | 1 | 1 | 1 |
| Bit 0 | 1 | 0 | 1 | 0 | 1 | 0 | 1 | 1 | 1 |

In the example of Table 2, the data word shown in clock cycle t+4 is the same data word received in signals DP in clock cycle t+1 and shown in Table 1. The data shown in Table 2 is provided as an example and is not intended to be limiting.

Bit shifter and counter circuit 301 then generates output signals BSB that indicate the number B of bit shifts performed on the bit shifted data to match the synchronization character. Signals BSB indicate the boundary between data words in the data bits indicated by signals DP. Signals BSB can be stored in registers in circuit 301. Signals BSB are provided to inputs of word alignment circuit 104.

Word alignment circuit 104 bit shifts data words received in signals DP by the number B of bits shifts indicated by signals BSB to generate data in data signals DA. In an exemplary embodiment, word alignment circuit 104 also determines if consecutive synchronization characters are within data words received in signals DP, according to a qualification of a transmission protocol. If word alignment circuit 104 detects the consecutive synchronization characters in data words received in signals DP, then word alignment circuit 104 bit shifts the data that is subsequently received in data signals DP by the number B indicated by signals BSB to generate bit shifted data. Word alignment circuit 104 then provides the bit shifted data to deskew circuit 105 as word aligned data signals DA. The words in data signals DA are then aligned to the correct word boundary.

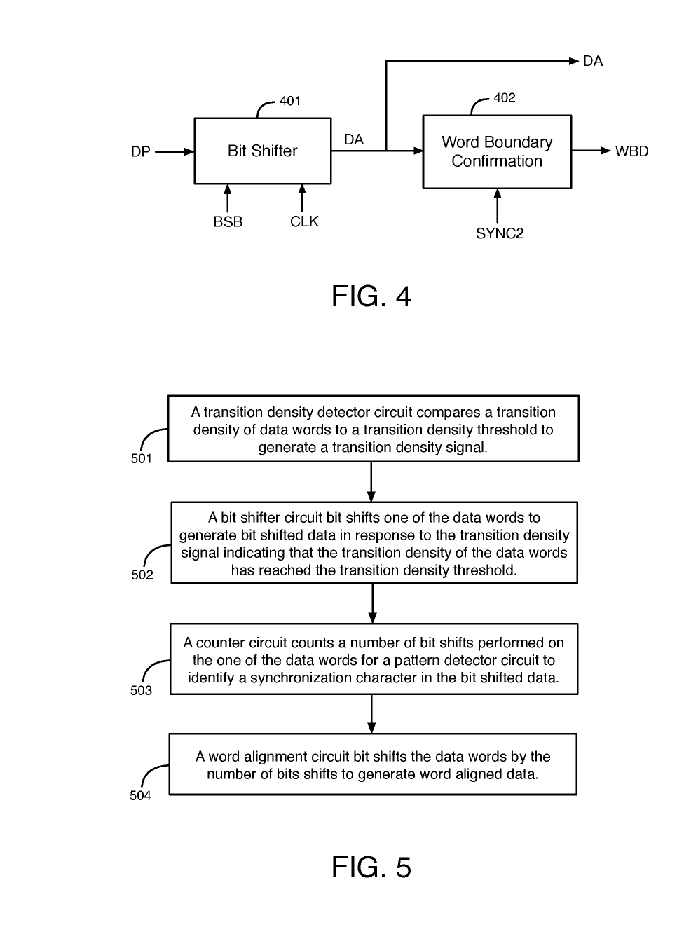

FIG. 4 illustrates details of an exemplary embodiment of the word alignment circuit 104 of FIG. 1. Word alignment circuit 104 includes a bit shifter circuit 401 and a word boundary confirmation circuit 402. Bit shifter circuit 401 receives parallel data in signals DP, clock signal CLK, and signals BSB as inputs. Bit shifter circuit 401 bit shifts data words received in signals DP by the number B indicated by signals BSB in response to clock signal CLK to generate bit shifted data in data signals DA. Signals DA are provided to inputs of word boundary confirmation circuit 402.

Word boundary confirmation circuit 402 compares the bit shifted data in data signals DA to synchronization characters indicated by signals SYNC2. The synchronization characters in SYNC2 can be sequences of bits that are defined by a transmission protocol, such as HDMI or another protocol. As an example that is not intended to be limiting, word boundary confirmation circuit 402 may attempt to detect 6 consecutive synchronization characters in 3 consecutive data words in signals DA.

If word boundary confirmation circuit 402 detects that the bit shifted data received in signals DA matches the synchronization characters indicated by signals SYNC2, then word boundary confirmation circuit 402 asserts its output signal WBD to indicate that the word boundary in the data has been correctly identified. Bit shifter circuit 401 can then bit shift each of the data words received in signals DP by the B number of bit shifts to generate bit shifted and word aligned data words in signals DA in response to signal WBD being asserted. Word alignment circuit 104 can then output each of the bit shifted data words indicated by signals DA to the de-skew circuit 105 in response to signal WBD being asserted.

Table 3 below shows examples of six 20-bit data words (bits 0-19) generated in signals DA by bit shifter 401 and analyzed by word boundary confirmation circuit 402.

TABLE 3

| Clock cycle | t + 13 | t + 14 | t + 15 | t + 16 | t + 17 | t + 18 |
|---|---|---|---|---|---|---|
| Bit 19 | 1 | 0 | 0 | 1 | 0 | 1 |
| Bit 18 | 1 | 0 | 0 | 1 | 1 | 1 |
| Bit 17 | 0 | 1 | 1 | 0 | 1 | 1 |
| Bit 16 | 1 | 0 | 0 | 0 | 0 | 0 |
| Bit 15 | 0 | 1 | 1 | 1 | 0 | 0 |
| Bit 14 | 1 | 0 | 0 | 1 | 0 | 0 |
| Bit 13 | 0 | 1 | 1 | 0 | 0 | 0 |
| Bit 12 | 1 | 0 | 0 | 0 | 0 | 0 |
| Bit 11 | 0 | 1 | 1 | 0 | 0 | x |
| Bit 10 | 0 | 1 | 1 | 1 | 0 | x |
| Bit 9 | 0 | 1 | 1 | 0 | 0 | x |
| Bit 8 | 0 | 1 | 1 | 0 | 1 | x |
| Bit 7 | 1 | 0 | 0 | 1 | 1 | x |
| Bit 6 | 0 | 1 | 1 | 0 | 1 | x |
| Bit 5 | 1 | 0 | 0 | 1 | 1 | x |
| Bit 4 | 0 | 1 | 1 | 1 | 0 | x |
| Bit 3 | 1 | 0 | 0 | 1 | 1 | x |
| Bit 2 | 0 | 1 | 1 | 0 | 1 | x |
| Bit 1 | 1 | 0 | 0 | 0 | 1 | x |
| Bit 0 | 1 | 0 | 0 | 0 | 0 | x |

In the example of Table 3, word boundary confirmation circuit 402 detects two 10-bit synchronization characters in each of the 20-bit data words received in signals DA in clock cycles t+13, t+14, and t+15 to confirm that the word boundary has been correctly detected. Each x in clock cycle t+18 indicates any bit value. The data shown in Table 3 is provided as an example and is not intended to be limiting.

If word boundary confirmation circuit 402 detects that the bit shifted data words received in signals DA do not match the consecutive synchronization characters indicated by signals SYNC2, then word boundary confirmation circuit 402 causes its output signal WBD to be in a de-asserted state to indicate that the word boundary in the data has not been identified. Word alignment circuit 104 can then, for example, cause receiver circuit 100 to perform another iteration of word alignment on subsequently received data words in signals DP in response to signal WBD being de-asserted.

Referring again to FIG. 1, de-skew circuit 105 de-skews the word aligned data indicated by signals DA to generate de-skewed data indicated by signals DD. Decoder circuit 106 decodes the de-skewed data indicated by signals DD to generate decoded output data bits in output data signals DOUT. The output data signals DOUT may then be provided to other circuitry in the integrated circuit for further processing.

Receiver circuit 100 of FIG. 1 has significant advantages over a bit-slipping technique to determine the word boundary in data signals. Receiver circuit 100 is capable of quickly determining the correct word boundary in response to detecting the first synchronization character. Receiver circuit 100 provides a synchronization lock time that is deterministic in a best case scenario as soon as the clock data recovery (CDR) circuit is locked and in a worst case scenario of up to 1 input data frame (e.g., 1 video frame for HDMI).

Receiver circuit 100 of FIG. 1 also has significant advantages over a pattern matching technique. For example, receiver circuit 100 can use a single stage comparator for pattern detection in circuit 303, while a pattern matching technique may need to use a series of comparators depending on the synchronization character width. A pattern matching word aligner iteratively performs protocol specific pattern detection and bit shifting based on the word boundary output within a single clock cycle. Receiver circuit 100, on the other hand, uses a transition density based word aligner, as disclosed herein, to detect high bit transition density data words and to perform synchronization character pattern detection through bit shifting (e.g., over multiple clock cycles). Receiver circuit 100 relaxes the timing and reduces the overall resource utilization. Receiver circuit 100 may, for example, achieve a resource saving in logic circuits of 50% for pattern detection.

In some embodiments, receiver circuit 100 of FIG. 1 may also have significant advantages over a hard word aligner in an ASIC that is external to circuitry that processes the input data. Receiver circuit 100 may not incur the additional cost of an external ASIC design. Also, if receiver circuit 100 is implemented in a programmable logic IC, receiver circuit 100 may have a shorter time to market than an external ASIC.

FIG. 5 illustrates examples of operations that can be performed to achieve word alignment of data based on the transition density of the data, according to an embodiment. In operation 501, a transition density detector circuit compares a transition density of data words to a transition density threshold to generate a transition density signal. The transition density signal indicates a number of logic state transitions in the data words. In operation 502, a bit shifter circuit bit shifts one of the data words to generate bit shifted data in response to the transition density signal indicating that the transition density of the data words has reached the transition density threshold. In operation 503, a counter circuit counts a number of bit shifts performed on the one of the data words for a pattern detector circuit to identify a synchronization character in the bit shifted data. In operation 504, a word alignment circuit bit shifts the data words by the number of bits shifts to generate word aligned data.

The embodiments disclosed herein can be incorporated into any suitable integrated circuit or system. For example, the embodiments disclosed herein can be incorporated into numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein may be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

The following examples pertain to further embodiments. Example 1 is a receiver circuit comprising: a transition density detector circuit that generates a transition density signal based on a comparison between a transition density of data words to a transition density threshold; a bit shift and pattern detector circuit that bit shifts one of the data words to generate bit shifted data in response to the transition density signal indicating that the transition density of the data words has reached the transition density threshold, wherein the bit shift and pattern detector circuit counts a number of bits shifts performed on the bit shifted data to locate a synchronization character; and a word alignment circuit that bit shifts the data words by the number of bits shifts to generate word aligned data.

In Example 2, the receiver circuit of Example 1 can optionally include, wherein the bit shift and pattern detector circuit further comprises: register circuits that store at least one of the data words in response to the transition density signal indicating that the transition density of the data words has reached the transition density threshold, wherein the bit shift and pattern detector circuit bit shifts one of the data words stored in the register circuits to generate the bit shifted data.

In Example 3, the receiver circuit of any one of Examples 1-2 can optionally include, wherein the word alignment circuit further comprises: a word boundary confirmation circuit that compares the word aligned data to additional synchronization characters and adjusts an output signal to indicate that a word boundary in the word aligned data has been correctly identified if the word aligned data matches the additional synchronization characters.

In Example 4, the receiver circuit of any one of Examples 1-3 can optionally include, wherein the transition density detector circuit comprises XOR logic gate circuits that compare adjacent pairs of bits in the data words to determine the transition density of the data words.

In Example 5, the receiver circuit of Example 4 can optionally include, wherein the transition density detector circuit further comprises a comparator circuit that compares the transition density of the data words generated by the XOR logic gate circuits to the transition density threshold to generate the transition density signal.

In Example 6, the receiver circuit of any one of Examples 1-5 can optionally include, wherein the bit shift and pattern detector circuit further comprises: a bit shifter and counter circuit that counts the number of bit shifts performed on the bit shifted data to cause a pattern detector circuit to generate a pattern detection signal indicating that the bit shifted data matches the synchronization character.

In Example 7, the receiver circuit of any one of Examples 1-6 can optionally further comprise: a serial-to-parallel converter circuit that converts serial data bits received in input signals into parallel data bits in the data words, wherein the data words are provided to inputs of the transition density detector circuit; and a de-skew circuit that de-skews the word aligned data to generate de-skewed data.

In Example 8, the receiver circuit of any one of Examples 1-7 can optionally further include, wherein the receiver circuit is in an integrated circuit, and wherein the transition density signal indicates a number of logic state transitions in each of the data words.

Example 9 is an integrated circuit comprising: a transition density detector circuit that compares a transition density of data words to a transition density threshold to generate a transition density signal, wherein the transition density signal indicates a number of logic state transitions in each of the data words; a bit shifter circuit that bit shifts one of the data words to generate bit shifted data in response to the transition density signal indicating that the transition density of the data words has reached the transition density threshold; a pattern detector circuit, wherein the bit shifter circuit counts a number of bit shifts performed on the one of the data words for the pattern detector circuit to identify a synchronization character in the bit shifted data; and a word alignment circuit that bit shifts the data words by the number of bits shifts to generate word aligned data.

In Example 10, the integrated circuit of Example 9 can optionally further comprise: register circuits that store at least one of the data words in response to the transition density signal indicating that the transition density of the data words has reached the transition density threshold, wherein the bit shifter circuit bit shifts one of the data words stored in the register circuits to generate the bit shifted data.

In Example 11, the integrated circuit of any one of Examples 9-10 can optionally include, wherein the word alignment circuit further comprises: a word boundary confirmation circuit that indicates that a word boundary in the word aligned data has been correctly identified if the word aligned data matches at least one additional synchronization character.

In Example 12, the integrated circuit of Example 11 can optionally include, wherein the word alignment circuit further comprises: an additional bit shifter circuit that bit shifts the data words by the number of bits shifts to generate the word aligned data, wherein the word aligned data is provided to the word boundary confirmation circuit.

In Example 13, the integrated circuit of Example 12 can optionally include, wherein the additional bit shifter circuit bit shifts each of the data words received from the transition density detector circuit by the number of bits shifts to generate the word aligned data in response to the word boundary confirmation circuit indicating that the word boundary in the word aligned data has been identified.

In Example 14, the integrated circuit of any one of Examples 9-13 can optionally include, wherein the transition density detector circuit comprises XOR logic gate circuits that compare adjacent pairs of bits in the data words to determine the transition density of the data words.

In Example 15, the integrated circuit of Example 14 can optionally include, wherein the transition density detector circuit further comprises a comparator circuit that compares the transition density of the data words generated by the XOR logic gate circuits to the transition density threshold to generate the transition density signal.

Example 16 is a method for word aligning data, the method comprising: comparing a transition density of data words to a transition density threshold to generate a transition density signal using a transition density detector circuit, wherein the transition density signal indicates logic state transitions in the data words; bit shifting one of the data words to generate bit shifted data using a bit shifter circuit in response to the transition density signal indicating that the transition density of the data words has reached the transition density threshold; counting a number of bit shifts performed on the one of the data words for a pattern detector circuit to identify a synchronization character in the bit shifted data; and bit shifting the data words by the number of bits shifts to generate word aligned data using a word alignment circuit.

In Example 17, the method of Example 16 can optionally further comprise: storing at least one of the data words in register circuits in response to the transition density signal indicating that the transition density of the data words has reached the transition density threshold; and providing one of the data words stored in the register circuits to the bit shifter circuit.

In Example 18, the method of any one of Examples 16-17 can optionally further comprise: indicating that a word boundary in the word aligned data has been identified if a word boundary confirmation circuit determines that the word aligned data matches additional synchronization characters.

In Example 19, the method of Example 18 can optionally further comprise, wherein bit shifting the data words by the number of bits shifts to generate the word aligned data using the word alignment circuit further comprises: bit shifting each of the data words received from the transition density detector circuit by the number of bits shifts to generate the word aligned data in response to the word boundary confirmation circuit indicating that the word boundary in the word aligned data has been identified.

In Example 20, the method of any one of Examples 16-19 can optionally further include, wherein comparing the transition density of data words to the transition density threshold to generate the transition density signal using the transition density detector circuit further comprises: comparing adjacent pairs of bits in the data words to determine the transition density of the data words using XOR logic gate circuits.

The foregoing description of the exemplary embodiments of the present invention has been presented for the purpose of illustration. The foregoing description is not intended to be exhaustive or to limit the present invention to the examples disclosed herein. In some instances, features of the present invention can be employed without a corresponding use of other features as set forth. Many modifications, substitutions, and variations are possible in light of the above teachings, without departing from the scope of the present invention.

What is claimed is:

1. A receiver circuit comprising:
a transition density detector circuit that generates a transition density signal based on a comparison between a transition density of data words to a transition density threshold;
a bit shift and pattern detector circuit that bit shifts one of the data words to generate bit shifted data in response to the transition density signal indicating that the transition density of the data words has reached the transition density threshold, wherein the bit shift and pattern detector circuit counts a number of bits shifts performed on the bit shifted data to locate a synchronization character; and
a word alignment circuit that bit shifts the data words by the number of bits shifts to generate word aligned data.

2. The receiver circuit of claim 1, wherein the bit shift and pattern detector circuit further comprises:
register circuits that store at least one of the data words in response to the transition density signal indicating that the transition density of the data words has reached the transition density threshold, wherein the bit shift and pattern detector circuit bit shifts one of the data words stored in the register circuits to generate the bit shifted data.

3. The receiver circuit of claim 1, wherein the word alignment circuit further comprises:
a word boundary confirmation circuit that compares the word aligned data to additional synchronization characters and adjusts an output signal to indicate that a word boundary in the word aligned data has been correctly identified if the word aligned data matches the additional synchronization characters.

4. The receiver circuit of claim 1, wherein the transition density detector circuit comprises XOR logic gate circuits that compare adjacent pairs of bits in the data words to determine the transition density of the data words.

5. The receiver circuit of claim 4, wherein the transition density detector circuit further comprises a comparator circuit that compares the transition density of the data words generated by the XOR logic gate circuits to the transition density threshold to generate the transition density signal.

6. The receiver circuit of claim 1, wherein the bit shift and pattern detector circuit further comprises:
a bit shifter and counter circuit that counts the number of bit shifts performed on the bit shifted data to cause a pattern detector circuit to generate a pattern detection signal indicating that the bit shifted data matches the synchronization character.

7. The receiver circuit of claim 1 further comprising:
a serial-to-parallel converter circuit that converts serial data bits received in input signals into parallel data bits in the data words, wherein the data words are provided to inputs of the transition density detector circuit; and
a de-skew circuit that de-skews the word aligned data to generate de-skewed data.

8. The receiver circuit of claim 1, wherein the receiver circuit is in an integrated circuit, and wherein the transition density signal indicates a number of logic state transitions in each of the data words.

9. An integrated circuit comprising:
a transition density detector circuit that compares a transition density of data words to a transition density threshold to generate a transition density signal, wherein the transition density signal indicates a number of logic state transitions in each of the data words;
a bit shifter circuit that bit shifts one of the data words to generate bit shifted data in response to the transition density signal indicating that the transition density of the data words has reached the transition density threshold;
a pattern detector circuit, wherein the bit shifter circuit counts a number of bit shifts performed on the one of the data words for the pattern detector circuit to identify a synchronization character in the bit shifted data; and
a word alignment circuit that bit shifts the data words by the number of bits shifts to generate word aligned data.

10. The integrated circuit of claim 9 further comprising:
register circuits that store at least one of the data words in response to the transition density signal indicating that the transition density of the data words has reached the transition density threshold, wherein the bit shifter circuit bit shifts one of the data words stored in the register circuits to generate the bit shifted data.

11. The integrated circuit of claim 9, wherein the word alignment circuit further comprises:
a word boundary confirmation circuit that indicates that a word boundary in the word aligned data has been correctly identified if the word aligned data matches at least one additional synchronization character.

12. The integrated circuit of claim 11, wherein the word alignment circuit further comprises:
an additional bit shifter circuit that bit shifts the data words by the number of bits shifts to generate the word aligned data, wherein the word aligned data is provided to the word boundary confirmation circuit.

13. The integrated circuit of claim 12, wherein the additional bit shifter circuit bit shifts each of the data words received from the transition density detector circuit by the number of bits shifts to generate the word aligned data in response to the word boundary confirmation circuit indicating that the word boundary in the word aligned data has been identified.

14. The integrated circuit of claim 9, wherein the transition density detector circuit comprises XOR logic gate circuits that compare adjacent pairs of bits in the data words to determine the transition density of the data words.

15. The integrated circuit of claim 14, wherein the transition density detector circuit further comprises a comparator circuit that compares the transition density of the data words generated by the XOR logic gate circuits to the transition density threshold to generate the transition density signal.

16. A method for word aligning data, the method comprising:
comparing a transition density of data words to a transition density threshold to generate a transition density signal using a transition density detector circuit, wherein the transition density signal indicates logic state transitions in the data words;
bit shifting one of the data words to generate bit shifted data using a bit shifter circuit in response to the transition density signal indicating that the transition density of the data words has reached the transition density threshold;
counting a number of bit shifts performed on the one of the data words for a pattern detector circuit to identify a synchronization character in the bit shifted data; and
bit shifting the data words by the number of bits shifts to generate word aligned data using a word alignment circuit.

17. The method of claim 16 further comprising:
storing at least one of the data words in register circuits in response to the transition density signal indicating that the transition density of the data words has reached the transition density threshold; and
providing one of the data words stored in the register circuits to the bit shifter circuit.

18. The method of claim 16 further comprising:
indicating that a word boundary in the word aligned data has been identified if a word boundary confirmation circuit determines that the word aligned data matches additional synchronization characters.

19. The method of claim 18, wherein bit shifting the data words by the number of bits shifts to generate the word aligned data using the word alignment circuit further comprises:
bit shifting each of the data words received from the transition density detector circuit by the number of bits shifts to generate the word aligned data in response to the word boundary confirmation circuit indicating that the word boundary in the word aligned data has been identified.

20. The method of claim 16, wherein comparing the transition density of data words to the transition density threshold to generate the transition density signal using the transition density detector circuit further comprises:
comparing adjacent pairs of bits in the data words to determine the transition density of the data words using XOR logic gate circuits.
